(19) United States
(12) Patent Application Publication
(10) Pub. No.: US 2007/0049149 A1
(43) Pub. Date: Mar. 1, 2007

(54) Chemical-resistant breathable textile laminate

(75) Inventor: Laurence F. Ellis, Hampton, CT (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Brookwood Companies, Inc.

(21) Appl. No.: 11/210,676

(22) Filed: Aug. 24, 2005

(51) Int. Cl. B32B 27/12; B32B 5/24; B32B 27/32; B32B 5/18

(52) U.S. Cl. 442/221; 442/286; 442/289; 442/301; 442/315; 442/370; 442/394; 442/397; 428/315.5; 428/318.4; 428/319.3; 428/319.7; 428/319.9; 427/389.9

(57) ABSTRACT

The present invention provides a fabric that can be used in various applications, that is breathable, waterproof, and resistant to common chemicals. The textile laminate includes a breathable chemical-resistant layer that is adhered to either a microporous membrane layer or a monolithic hydrophilic layer. The chemical-resistant layer is a hydrophilic polyurethane film that balances the chemical-resistant components of its formulation with the components that provide breathability, such that a textile laminate is created that resists common chemicals while maintaining a high degree of breathability.

### FIELD OF THE INVENTION

The present invention relates to breathable, waterproof textile laminates. More specifically, the invention relates to textile laminates useful in the production of various products, including apparel for recreational, industrial, military, medical applications, and the like, that are waterproof, breathable, and resistant to chemical contaminants. The invention also relates to a method of producing such a laminate.

### BACKGROUND OF THE INVENTION

Waterproof textile laminates are important in various applications, where exposure to moisture or high humidity is likely. In such applications, the textile laminates may be used to shed or absorb moisture so as to keep water from penetrating through the laminate. This function serves an important purpose by allowing the laminate to act as a protectant layer. For some applications, merely the ability to shed or absorb water may serve this purpose adequately, however, in many other applications, especially recreational, industrial, military, medical and like applications, it may be advantageous that the textile laminate not only be waterproof, but breathable as well.

Waterproof laminates are especially useful in the garment and apparel industry. Moreover, in applications where the garment is worn by a user, the ability of the laminate to breathe is an important factor in the user's comfort level. Non-breathable textile fabrics tend to be uncomfortable, because moisture given off by the body is retained within the interior space defined by the textile fabric. In these situations, the moisture remains adjacent the user's body and, in humid environments, this may increase user perspiration. Additionally, moisture trapped near a user's body in a cold environment may precipitate hypothermia.

Conventional solutions for creating a breathable waterproof garment include the use of vent features. These features typically include waterproof flaps that overlap non-waterproof areas of the garment. Usually, the features are spaced widely across the garment, and/or are located at the seams. Because such vents are spaced apart, however, the garment is only breathable in those areas containing the vents. Additionally, because the vent features have flaps that overlap non-waterproof areas, they are not impervious to water, especially if the garment is exposed to water in large amounts or if water enters underneath the flap.

It is now recognized that rather than utilizing air vents, transporting the water vapor contained in perspiration away from the user provides adequate comfort. A textile fabric's ability to transport water vapor through its thickness is commonly referred to as its “breathability.” Textile fabric constructions have been developed that provide both waterproofness and breathability. For example, U.S. Pat. No. 6,511,927 to Ellis, et al. describes a waterproof breathable fabric construction, the disclosure of which is incorporated herein by reference.

In general, these constructions are laminates that incorporate a polymeric film, also referred to as a membrane. Two typical types of breathable films are: monolithic membrane films and microporous membrane films. Monolithic films are extremely hydrophilic in nature (i.e. water-loving or absorbing). They “solubilize” water vapor within their molecular chains and transport individual water molecules through their thickness by molecular diffusion. Thus, monolithic films are nonporous and provide the additional benefit of air-impermeability, or “windproofness.” Microporous films, on the other hand, are hydrophobic in nature (i.e. water-hating or repelling). Microporous films are generally characterized by a multiplicity of micropores that are too small to allow liquid water to pass, but are large enough to permit water vapor to readily flow through. Expanded polytetrafluoroethylene film (“e-PTFE”) is a widely known example of such a microporous film. A process of creating e-PTFE is described in U.S. Pat. No. 3,953,566 to Gore, the disclosure of which is incorporated herein by reference.

Coatings on the side nearest a user have been used to protect the pores of microporous films, because it is believed that the films are adversely affected by exposure to surface active agents present during wear or laundering. These coatings are applied to the microporous membrane as either a continuous layer of a liquid solution or a molten application. Although providing protection, coatings penetrate the surface of the microporous film and stiffen the resulting laminate. Several coated microporous membranes are marketed by W. L. Gore and Associates, Inc., under the tradename GORE-TEX®. Examples of coated e-PTFE fabrics are described in U.S. Pat. No. 4,194,041 to Gore et al. and U.S. Pat. No. 5,026,591 to Henn et al, the disclosures of which are incorporated herein by reference.

Recently, a need has arisen to create textile laminates that are also resistant to common chemical contaminants. These contaminants include insect repellants that may be harmful to users if absorbed by the skin, such as N,N-diethyl-m-toluamide (commonly known as DEET). They also include other contaminants that may be harmful to users and that typically break down the structure of fabrics, such as acids and common petroleum-based chemicals such as fuel oils, motor oils, etc. Often, these contaminants are encountered in recreational, industrial, military, medical and other similar applications.

It is known in the art that the use of an impervious barrier, such as a PVC or a butyl rubber coating, placed on a protective laminate between the environment and the user's skin may provide protection from these contaminants. However, although a PVC or butyl rubber coating resists the penetration of these contaminants, these and similar coatings resist the permeation of water vapor as well. Furthermore, the types of applications where these contaminants are often encountered include those in which breathable garments are desired. As a result, a protective garment having these or similar coatings may only be worn for a short period of time, after which a user will experience discomfort because of the garment's inability to breathe. As a result, there is a need for a textile laminate that is not only waterproof and resistant to chemical contaminants, but that is sufficiently breathable as well.

One approach to providing a chemically resistant laminate having breathability characteristics is described in U.S. Patent Application Publication 2004/0259446, the disclosure of which is incorporated herein by reference. This approach creates a water vapor permeable laminate by including at least one layer of a sulfonated aromatic polymer that is said to impart permeability to water vapor while remaining relatively impervious to noxious chemicals. It has been determined, however, that the amount of sulfonation required to impart the requisite amount of breathability should be closely controlled. Too much sulfonation may cause the laminate to swell when exposed to water vapor, whereas too little sulfonation may not impart enough breathability, rendering the laminate insufficiently permeable to water vapor. Additionally, this process may be relatively complicated and expensive to complete.

Thus, there remains a need for a non-sulfonated laminate construction having a high degree of breathability and waterproofness, and which is resistant to common chemicals. The laminate should be constructed such that it may be used in protective materials, including garments. The fabric should provide adequate drape and softness, thus being comfortable to wear, and should retain its breathability, waterproofness and resistance to chemicals through use, cleaning, laundering, and restoration. Furthermore, a need exists for a process for making such a material in an efficient and cost effective manner.

### BRIEF SUMMARY OF THE INVENTION

The present invention provides a fabric for various applications that is breathable, waterproof, and resistant to common chemicals. The textile laminate includes a breathable chemical-resistant layer that is adhered to either a microporous membrane layer or a monolithic hydrophilic layer. The chemical-resistant layer is a hydrophilic polyurethane film that balances chemical-resistant components of its formulation with components that provide breathability, such that a textile laminate is created that resists common chemicals while maintaining a high degree of breathability.

In one embodiment, the present invention includes a breathable, waterproof, chemical-resistant textile laminate that has a microporous membrane layer and a breathable chemical-resistant layer. The microporous membrane layer is a hydrophobic film that has a plurality of pores of a size large enough to allow water vapor to pass therethrough but small enough to resist the passage of liquid water. The breathable chemical-resistant layer is a hydrophilic polyurethane film adhered to the microporous membrane layer. The textile laminate is oriented such that the microporous membrane layer is adjacent to a user. The breathable chemical-resistant layer may be an aromatic polyether polyurethane that has an aliphatic cross-linker, and may be cast directly onto the microporous membrane layer. The microporous membrane layer may be expanded polytetrafluoroethylene.

A fabric layer can be adhered to either the microporous membrane layer or the breathable chemical-resistant layer with an adhesive. In particular a fabric layer is bonded to the breathable chemical-resistant layer with a first adhesive and a lining layer is bonded to the microporous membrane layer with a second adhesive. At least one of the first or second adhesives may be a breathable polyether polyurethane adhesive.

In another embodiment, a breathable, waterproof, chemical-resistant textile laminate includes a monolithic hydrophilic layer and a breathable chemical-resistant layer. The monolithic hydrophilic layer may be chosen from the group consisting of polyurethane, polyester, and/or copolyether layers. As above, a fabric layer can be bonded to the breathable chemical-resistant layer with a first adhesive and a lining layer bonded to the monolithic hydrophilic layer with a second adhesive.

In another embodiment, the present invention includes a method of constructing a breathable, waterproof, chemical-resistant textile laminate. The method includes providing a breathable chemical-resistant hydrophilic polyurethane in solution form and casting the solution directly onto a microporous membrane layer to form a breathable chemical-resistant layer. The laminate is then dried in an oven in order to crosslink the system. The casting step can also be performed onto a monolithic hydrophilic layer. The method may also include bonding a fabric layer to at least one of the microporous layer and the breathable chemical-resistant layer with a first adhesive, and may further include bonding a second fabric layer to the other of the microporous membrane layer and the breathable chemical-resistant layer with a second adhesive. At least one of the first adhesive and the second adhesive may be a breathable polyether polyurethane adhesive. The breathable chemical-resistant hydrophilic polyurethane may be comprised of an aromatic polyether polyurethane having an aliphatic cross-linker. Also, the microporous layer may be comprised of expanded polytetrafluoroethylene.

In still another embodiment, the present invention includes a hydrophilic film for use in waterproof breathable textiles, comprising an aromatic polyether polyurethane having an aliphatic cross-linker for balancing breathability with chemical resistance.

The fabric of the present invention has several advantages that provide a non-sulfonated textile laminate, that is breathable, waterproof, and resistant to common chemical contaminants, such as insect repellants, petroleum-based contaminants, and the like that are typically encountered in recreational, industrial, military, medical, and other applications. The textile laminate includes a breathable chemical-resistant layer that is a hydrophilic polyurethane film constructed to balance the components of its formulation that provide chemical resistance with those that provide breathability, such that the breathable chemical-resistant layer resists chemical contaminants while maintaining a high degree of breathability. The textile laminate also includes a breathable membrane layer that is oriented nearest a user. The breathable membrane layer is a microporous membrane layer or a monolithic hydrophilic layer. The textile laminate may also include a face layer bonded by a breathable adhesive that provides a durable outer fabric, and a lining layer bonded by a breathable adhesive that provides a comfortable layer between the user and the other layers. As a result, the present invention provides a breathable chemical-resistant textile laminate that provides adequate drape and softness, is comfortable to wear, and retains its breathability waterproofness and chemical resistance through use, cleaning, laundering, and restoration.

### BRIEF DESCRIPTION OF THE DRAWINGS

Having thus described the invention in general terms, reference will now be made to the accompanying drawings, which are not necessarily drawn to scale, and wherein:

FIG. 1 is an enlarged cross-sectional view of one advantageous embodiment of the present invention;

FIG. 2 is an enlarged cross-sectional view of another advantageous embodiment of the present invention;

FIG. 3 is an enlarged cross-sectional view of another advantageous embodiment of the present invention;

FIG. 4 is an enlarged cross-sectional view of another advantageous embodiment of the present invention;

FIG. 5 is an enlarged cross-sectional view of another advantageous embodiment of the present invention; and

FIG. 6 is an enlarged cross-sectional view of another advantageous embodiment of the present invention.

### DETAILED DESCRIPTION OF THE INVENTION

The present invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. Like numbers refer to like elements throughout.

As noted above, it had been previously believed that microporous membranes, such as e-PTFE, required coatings on the side nearest a user in order to protect the pores of the microporous films, as indicated in U.S. Pat. No. 4,194,041 to Gore et al. and U.S. Pat. No. 5,026,591 to Henn et al. However, the present inventors have determined that the performance of the microporous membrane layer does not significantly suffer in the absence of a coating on the side of the microporous membrane layer nearest the user. Additionally, the present inventors have determined that a breathable chemical-resistant layer may be applied to the side of a microporous membrane layer opposite the user in order to create a textile laminate that has a high degree of breathability and waterproofness, and which is resistant to common chemicals.

As a result, a laminated fabric is provided that has at least two layers that in combination provide a waterproof and breathable textile laminate that is resistant to common chemical contaminants such as insect repellants, acids and common petroleum-based chemicals such as fuel oils, motor oils, etc. This laminate further retains its breathability, waterproofness, and resistance to chemicals through use, cleaning, laundering, and restoration, and also provides adequate drape and softness.

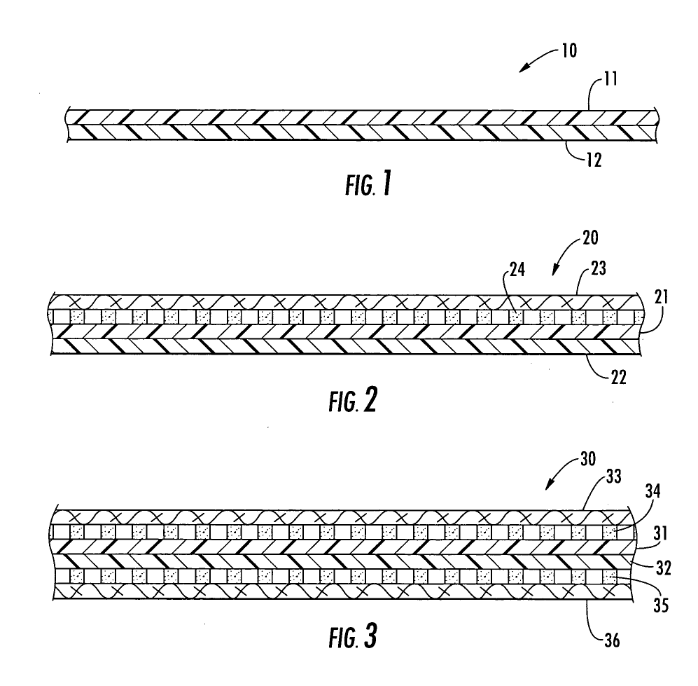

Referring to FIG. 1, generally the present invention in one embodiment includes a textile laminate 10 having a breathable chemical-resistant layer 11 and a microporous membrane layer 12, wherein the microporous membrane layer 12 is located nearest a user.

The breathable chemical-resistant layer 11 is a hydrophilic polyurethane film. The composition of the breathable chemical-resistant layer 11 strikes a balance between chemical resistance and breathability. The breathable chemical-resistant layer 11 is designed so that it will resist common chemical contaminants that may be harmful to a user if exposed to the user's skin. As noted above, an example of such a contaminant is N,N-diethyl-m-toluamide (commonly known as DEET). The breathable chemical-resistant layer 11 is also designed to be resistant to other contaminants that typically break down the structure of fabrics, such as acids and common petroleum-based chemicals such as fuel oils, motor oils, etc. In one advantageous embodiment, the hydrophilic polyurethane film is an aromatic polyether polyurethane having an aliphatic cross-linker. This formulation is a blend of aromatic and aliphatic components. In one embodiment, a pure aromatic in liquid form, is catalyzed with approximately a 3% aliphatic cross-linker, such as product HB100 from Ciba Specialty Chemicals, resulting in a chemical resistant layer 11 having a weight of approximately 0.2-0.6 oz/yd². The aliphatic component is included for chemical resistance and the aromatic component is included for breathability. The hydrophilic polyurethane film is thus formulated to balance chemical resistance, which is advantageous for protecting a user and the fabric laminate from chemical contaminants, and breathability, which is advantageous for textile laminates used in recreational, industrial, military, medical applications, and other applications where permeation of water vapor is desired.

The microporous membrane layer 12 utilized in the present invention is hydrophobic in nature and is further characterized by a multiplicity of micropores. In general, the microporous membrane layer 12 also provides strength to the laminate and support for the breathable chemical-resistant layer 11, and has stable chemical properties. The microporous membrane layer 12 is further selected from those having an air permeability on the order of about 0.50-7 cfm/ft², a thickness of about 10-80 microns, and pore sizes ranging from 0.25-10.0 microns. Membrane weights from 0.20 to 1.5 oz/yd² are useful, with 0.50 to 0.75 oz/yd² preferred. Known hydrophobic microporous membranes include e-PTFE. In one advantageous embodiment, the microporous membrane layer 12 is e-PTFE. In a further aspect of that advantageous embodiment, e-PTFE film having a thickness of approximately 2 mils (51 microns) is employed. In the depicted embodiment, the chemical-resistant layer 11 is cast directly onto the microporous membrane layer 12.

FIG. 2 shows another embodiment of a textile laminate 20 of the present invention. This embodiment includes a chemical-resistant layer 21, a microporous membrane layer 22, and a face layer 23, wherein the microporous membrane layer 22 is located nearest a user.

The face layer 23 is comprised of a fabric and is positioned furthest from the user, where it is exposed to the environment. Therefore, in general, the face layer 23 is a heavy, durable fabric, preferably chosen to withstand conditions encountered in recreational, industrial, medical, and similar applications. In one advantageous embodiment, the face fabric is a stretch resistant material. The face fabric is desirably selected from those having a weight range of about 1 to about 10 oz/yd², and can have any desired fiber composition (e.g. synthetic or natural or blends thereof) or construction (woven, knit, nonwoven, and the like). For example, fabrics of woven nylon have been found to perform well in the instant invention. In one advantageous embodiment, a 2.7 oz/yd² woven TASLAN nylon fabric is employed. In addition, the face layer 23 may be dyed or printed prior to securing it to the breathable chemical-resistant layer 21, as is known in the art. A durable water repellant (‘DWR’) finish may also be added to the face layer 23 to improve water repellency after repeated wearing and laundering. In one embodiment, the finish may comprise Zonal 8412 distributed by Ciba Specialty Chemicals.

In the depicted embodiment of FIG. 2, the face layer 23 is bonded to the breathable chemical-resistant layer 21 using a first adhesive 24. The first adhesive 24 can be a breathable adhesive, and the term “breathable adhesive” as used herein refers to a hydrophilic adhesive. The breathable hydrophilic adhesive is selected to provide high water vapor transmission, as well as good adhesion between the layers. Exemplary breathable adhesives include polyether polyurethane. In particular, moisture cured polyether polyurethane adhesives have been found to perform well in the invention. In one advantageous embodiment, 52282 Clear Comfortex Basecoat sold by Raffi & Sons Inc. of Wilmington, Mass. is applied, although such moisture cured polyether polyurethane adhesives are available from other suppliers, as well.

The first adhesive 24 is applied to the microporous membrane in a discontinuous pattern. As used herein, the term “discontinuous” means that the adhesive does not completely cover the bonding surface. In the depicted embodiment, the first adhesive 24 is applied by direct gravure coating. It is well known to use engraved gravure rolls to deposit a range of discontinuous coating patterns on a substrate. Typical discontinuous adhesive patterns include slanted (also referred to as “helical”) lines, dots, and cross hatch. In a preferred embodiment of the present invention, the gravure roll applies a discontinuous pattern of adhesive in a series of solid helical lines. The adhesive is desirably applied at a rate of coverage of about 20-40%, in weights ranging about 0.25 to about 0.35 oz/yd².

FIG. 3 shows another embodiment of a textile laminate 30 of the present invention. This embodiment includes a chemical-resistant layer 31, a microporous membrane layer 32, a face layer 33, and a lining layer 36, wherein the lining layer 36 is located nearest a user.

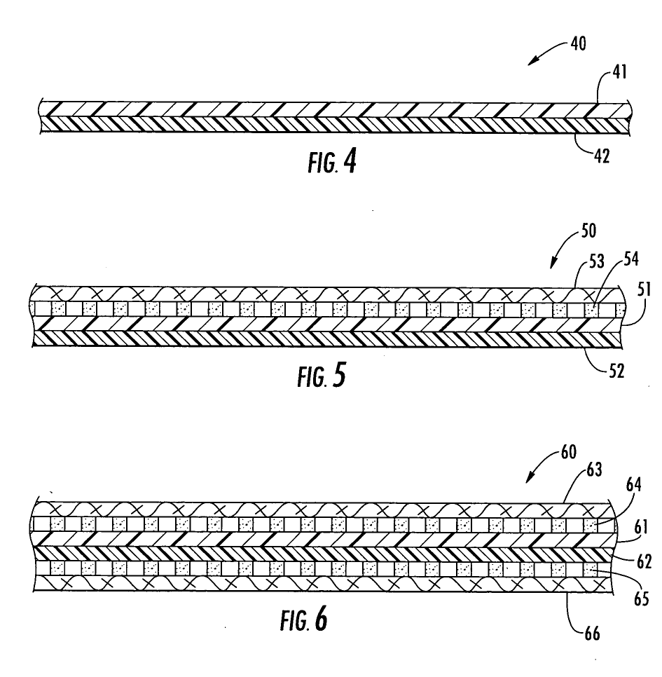

The lining layer 36 is a fabric and may be formed from nylon or polyester having a weight ranging from about 0.5 oz/yd² to about 4 oz/yd². In one advantageous embodiment, the lining layer 36 is desirably a tricot knit nylon fabric. The lining layer 36 is primarily intended to protect microporous layer 32 from abrasion and to create a comfortable layer for placing adjacent to a user's skin. Therefore, the lining layer 36 is generally recommended in those embodiments in which the waterproof breathable laminate is intended for direct contact with the user or wearer. The lining layer 36 is bonded to the microporous membrane layer 32 using a second adhesive 35. The second adhesive 35 is a breathable adhesive. As with a first adhesive 34 that bonds the face layer 33 to the chemical-resistant layer 34, the breathable adhesive is a hydrophilic adhesive. The breathable hydrophilic adhesive is selected to provide high water vapor transmission, as well as good adhesion between the layers. Exemplary breathable adhesives include polyether polyurethane. In particular, moisture cured polyether polyurethane adhesives have been found to perform well in the invention. In one advantageous embodiment, 52282 Clear Comfortex Basecoat sold by Raffi & Sons Inc. of Wilmington, Mass. is applied, although such moisture cured polyether polyurethane adhesives are available from other suppliers, as well.

Whereas the microporous membrane layers described above are breathable because of their multiplicity of micropores, monolithic films are extremely hydrophilic in nature and are breathable because they “solubilize” water vapor within their molecular chains and transport individual water molecules through their thickness by molecular diffusion. Thus, FIG. 4, FIG. 5, and FIG. 6 show other embodiments of the present invention where a monolithic hydrophilic layer is substituted for the microporous membrane layer of the embodiments described above. Specifically, the depicted embodiments show textile laminates 40, 50, 60 having breathable chemical-resistant layers 41, 51, 61, that are cast directly onto monolithic hydrophilic layers 42, 52, 62, respectively. Alternatively, the breathable chemical-resistant layers 41, 51, 61 may be coextruded or formed as separate films and then laminated. Monolithic hydrophilic layers 42, 52, 62 are nonporous and can be polyester, polyurethane, or other thermoplastic elastomer films that are capable of solubilizing water vapor within their molecular chains and transporting individual water molecules through their thicknesses by molecular diffusion.

In the embodiments depicted in FIG. 4 and FIG. 5, the monolithic hydrophilic layers 42, 52 are oriented nearest a user. The embodiments depicted in FIG. 5 and FIG. 6 also include face layers 53, 63 that are bonded to breathable chemical-resistant layers 51, 61, respectively. In the embodiment depicted in FIG. 6, a lining layer 66 that is bonded to the monolithic hydrophilic layer 62 is included such that the lining layer 66 is oriented nearest the user.

It should be noted that breathable chemical-resistant layers 41, 51, 61 are the same as or similar to the breathable chemical-resistant layers 11, 21, 31 described above in reference to the embodiments of FIG. 1, FIG. 2, and FIG. 3. Likewise, face layers 53, 63 are the same as or similar to face layers 23, 33 described above in reference to the embodiments of FIG. 2 and FIG. 3. Also, lining layer 66 depicted in FIG. 6 is the same as or similar to lining layer 36 described above in reference to the embodiment depicted in FIG. 3.

With reference to FIG. 5 and FIG. 6, it should also be noted that face layers 53 and 63 are bonded to chemical-resistant layers 51, 61 using first breathable adhesives 54, 64, respectively, and that first breathable adhesives 54, 64 are the same as or similar to first breathable adhesives 24, 34 as described above in reference to FIG. 2 and FIG. 3. Likewise, lining layer 66 is bonded to monolithic hydrophilic layer 62 using a second breathable adhesive 65 that is the same as or similar to the second breathable adhesive 35 described above in reference to FIG. 3.

The fabric of the present invention has several advantages that provide a non-sulfonated textile laminate, that is breathable, waterproof, and resistant to common chemicals, such as insect repellants, petroleum-based contaminants, and the like that are typically encountered in recreational, industrial, military, medical, and other applications. The textile laminate 10, 20, 30, 40, 50, 60 includes a breathable chemical-resistant layer 11, 21, 31, 41, 51, 61 that is a hydrophilic polyurethane film constructed to balance the components of its formulation that provide chemical resistance with those that provide breathability, such that the breathable chemical-resistant layer 11, 21, 31, 41, 51, 61 resists chemicals while maintaining a high degree of breathability. The textile laminate 10, 20, 30, 40, 50, 60 also includes a breathable membrane layer which is oriented nearest a user. The breathable membrane layer is a microporous membrane layer 12, 22, 32 or a monolithic hydrophilic layer 42, 52, 62. The textile laminate 20, 30, 50, 60 may also include a face layer 23, 33, 53, 63 bonded by a breathable adhesive 24, 34, 54, 64 that provides a durable outer fabric, and a lining layer 36, 66 bonded by a breathable adhesive 35, 65 that provides a comfortable layer between the user and the other layers. As a result, the present invention provides a breathable chemical-resistant textile laminate that provides adequate drape and softness, is comfortable to wear, and retains its breathability waterproofness and chemical resistance through use, cleaning, laundering, and restoration.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A textile laminate having both waterproof and breathable properties for comfortably protecting a user from the environment, said textile laminate further being resistant to chemicals and comprising:
a microporous membrane layer comprising a hydrophobic film having a plurality of pores of a size large enough to allow water vapor to pass therethrough but small enough to resist the passage of liquid water, said microporous membrane layer defining an inner side and an outer side;
a breathable layer defining an inner side and an outer side, said inner side of the breathable layer being adhered to the outer side of said microporous membrane layer, and wherein the breathable layer comprises a hydrophilic and chemical-resistant polymer; and
an outer fabric layer adhered to the outer side of the breathable layer such that the microporous membrane layer is on the opposite side of the breathable layer from the outer fabric layer and is closer to the user than the breathable layer.

2. A breathable, waterproof, chemical-resistant textile laminate of claim 1, wherein said breathable layer is comprised of an aromatic polyether polyurethane having an aliphatic polyurethane cross-linker.

3. A breathable, waterproof, chemical-resistant textile laminate of claim 1, wherein said breathable layer is cast directly onto said microporous membrane layer.

4. A breathable, waterproof, chemical-resistant textile laminate of claim 1, wherein said microporous membrane layer is expanded polytetrafluoroethylene.

5. A breathable, waterproof, chemical-resistant textile laminate of claim 1, wherein said outer fabric layer is adhered using a breathable polyether polyurethane adhesive.

6. A textile laminate having both waterproof and breathable properties for comfortably protecting a user from the environment, said textile laminate further being resistant to chemicals and comprising:
a microporous membrane layer comprising a hydrophobic film having a plurality of pores of a size large enough to allow water vapor to pass therethrough but small enough to resist the passage of liquid water, said microporous membrane layer defining an inner side and an outer side;
a breathable layer defining an inner side and an outer side, said inner side of the breathable layer being adhered to the outer side of said microporous membrane layer, and wherein the breathable layer comprises a hydrophilic and chemical-resistant polymer;
an outer fabric layer adhered to the outer side of the breathable layer such that the microporous membrane layer is on the opposite side of the breathable layer from the outer fabric layer and is closer to the user than the breathable layer; and
an inner lining layer formed of a fabric which is adhered to the inner side of said microporous membrane layer.

7. A breathable, waterproof, chemical-resistant textile laminate of claim 6, wherein said breathable layer is comprised of an aromatic polyether polyurethane having an aliphatic polyurethane cross-linker.

8. A breathable, waterproof, chemical-resistant textile laminate of claim 6, wherein said breathable layer is cast directly onto said microporous membrane layer.

9. A breathable, waterproof, chemical-resistant textile laminate of claim 6, wherein said microporous membrane layer is expanded polytetrafluoroethylene.

10. A breathable, waterproof, chemical-resistant textile laminate of claim 6, wherein at least one of said outer fabric layer and said inner lining layer is adhered using a breathable polyether polyurethane adhesive.

11. A laminate for use in textiles and having both waterproof and breathable properties for comfortably protecting a user from the environment, said laminate further being resistant to chemicals and comprising:
a microporous membrane layer comprising a hydrophobic film having a plurality of pores of a size large enough to allow water vapor to pass therethrough but small enough to resist the passage of liquid water, said microporous membrane layer defining an inner side and an outer side; and
a breathable layer defining an inner side and an outer side, said inner side of the breathable layer being adhered to the outer side of said microporous membrane layer so that the microporous membrane layer is closer to the user than the breathable layer;
wherein the breathable layer comprises a hydrophilic and chemical-resistant polymer.

12. A breathable, waterproof, chemical-resistant laminate of claim 11, wherein said breathable layer is comprised of an aromatic polyether polyurethane having an aliphatic polyurethane cross-linker.

13. A breathable, waterproof, chemical-resistant laminate of claim 11, wherein said breathable layer is cast directly onto said microporous membrane layer.

14. A breathable, waterproof, chemical-resistant laminate of claim 11, wherein said microporous membrane layer is expanded polytetrafluoroethylene.

15. A textile laminate having both waterproof and breathable properties for comfortably protecting a user from the environment, said textile laminate further being resistant to chemicals and comprising:
a monolithic hydrophilic layer, said monolithic hydrophilic layer defining an inner side and an outer side;
a breathable layer defining an inner side and an outer side, said inner side of the breathable layer being adhered to the outer side of said monolithic hydrophilic layer, and wherein the breathable layer comprises a hydrophilic and chemical-resistant polymer; and
an outer fabric layer adhered to the outer side of the breathable layer such that the monolithic hydrophilic layer is on the opposite side of the breathable layer from the outer fabric layer and is closer to the user than the breathable layer.

16. A breathable, waterproof, chemical-resistant textile laminate of claim 15, wherein said breathable layer is comprised of an aromatic polyether polyurethane having an aliphatic polyurethane cross-linker.

17. A breathable, waterproof, chemical-resistant textile laminate of claim 15, wherein said breathable layer is cast directly onto said monolithic hydrophilic layer.

18. A breathable, waterproof, chemical-resistant textile laminate of claim 15, wherein said monolithic hydrophilic layer comprises a material chosen from the group consisting of polyurethane, polyester, and copolyether.

19. A breathable, waterproof, chemical-resistant textile laminate of claim 15, wherein said outer fabric layer is adhered using a breathable polyether polyurethane adhesive.

20. A textile laminate having both waterproof and breathable properties for comfortably protecting a user from the environment, said textile laminate further being resistant to chemicals and comprising:
a monolithic hydrophilic layer, said monolithic hydrophilic layer defining an inner side and an outer side;
a breathable layer defining an inner side and an outer side, said inner side of the breathable layer being adhered to the outer side of said monolithic hydrophilic layer, and wherein the breathable layer comprises a hydrophilic and chemical-resistant polymer;
an outer fabric layer adhered to the outer side of the breathable layer such that the monolithic hydrophilic layer is on the opposite side of the breathable layer from the outer fabric and is closer to the user than the breathable layer; and
an inner lining layer formed of a fabric which is adhered to the inner side of said monolithic hydrophilic layer.

21. A breathable, waterproof, chemical-resistant textile laminate of claim 20, wherein said breathable layer is comprised an aromatic polyether polyurethane film having an aliphatic polyurethane cross-linker.

22. A breathable, waterproof, chemical-resistant textile laminate of claim 20 wherein said breathable layer is cast directly onto said monolithic hydrophilic layer.

23. A breathable, waterproof, chemical-resistant textile laminate of claim 20, wherein said monolithic hydrophilic layer comprises a material chosen from the group consisting of polyurethane, polyester, and copolyether.

24. A breathable, waterproof, chemical-resistant textile laminate of claim 20, wherein at least one of said outer fabric layer and said inner lining layer is adhered using a breathable polyether polyurethane adhesive.

25. A laminate for use in textiles and having both waterproof and breathable properties for comfortably protecting a user from the environment, said laminate further being resistant to chemicals and comprising:
a monolithic hydrophilic layer, said monolithic hydrophilic layer defining an inner side and an outer side; and
a breathable layer defining an inner side and an outer side, said inner side of the breathable layer being adhered to the outer side of said monolithic hydrophilic layer so that the monolithic hydrophilic layer is closer to the user than the breathable layer;
wherein the breathable layer comprises a hydrophilic and chemical-resistant polymer.

26. A breathable, waterproof, chemical-resistant laminate of claim 25, wherein said breathable layer is comprised of an aromatic polyether polyurethane having an aliphatic polyurethane cross-linker.

27. A breathable, waterproof, chemical-resistant laminate of claim 25, wherein said breathable layer is cast directly onto said monolithic hydrophilic layer.

28. A breathable, waterproof, chemical-resistant laminate of claim 25, wherein said monolithic hydrophilic layer is chosen from the group consisting of polyurethane, polyester, and copolyether.

29. A method of constructing a laminate for use in textiles having both waterproof and breathable properties for comfortably protecting a user from the environment, said laminate further being resistant to chemicals, said method comprising:
forming a breathable chemical-resistant hydrophilic polymer in solution form;
casting the solution directly onto one of a microporous membrane layer or a monolithic hydrophilic layer to form a breathable chemical-resistant layer adhered to the microporous membrane layer or monolithic hydrophilic layer; and
drying the layers.

30. A method of constructing a breathable, waterproof, chemical-resistant laminate of claim 29, wherein said forming step for the breathable chemical-resistant hydrophilic polymer further comprises cross-linking an aromatic polyether polyurethane with an aliphatic polyurethane cross-linker.

31. A method of constructing a breathable, waterproof, chemical-resistant laminate of claim 29, further comprising:
bonding a fabric layer to the laminate with a breathable polyether polyurethane adhesive.

32. A method of constructing a breathable, waterproof, chemical-resistant laminate of claim 31, further comprising:
bonding a second fabric layer to the other side of the laminate with a second adhesive.

33. A method of constructing a breathable, waterproof, chemical-resistant laminate of claim 29, wherein the microporous membrane layer is formed by expanding polytetrafluoroethylene.

34. A method of constructing a breathable, waterproof, chemical-resistant textile laminate of claim 29, wherein the monolithic hydrophilic layer is chosen from the group consisting of polyurethane, polyester, and copolyether.
